(19) United States
(12) Patent Application Publication
(10) Pub. No.: US 2010/0211891 A1
(43) Pub. Date: Aug. 19, 2010

(54) Widgetized avatar and a method and system of creating and using same including storefronts

(75) Inventor: Robb Fujioka, Manhattan Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: FUHU, INC., El Segundo, CA (US)

(21) Appl. No.: 12/628,031

(22) Filed: Nov. 30, 2009

Related U.S. Application Data
(63) Continuation-in-part of application No. 12/381,663, filed on Mar. 13, 2009.
Application No. 12/381,663 is a continuation-in-part of application No. 12/592,207, filed on Nov. 20, 2009.
(60) Provisional application No. 61/207,980, filed on Feb. 17, 2009.

(51) Int. Cl. G06F 3/048; G06F 15/16

(52) U.S. Cl. 715/757

(57) ABSTRACT

An avatar is disclosed. The avatar includes computing code that provides for addition of the avatar as non-static content to at least two unique at least partially static web pages, and secondary computing code resident within the computing code, wherein the secondary computing code provides for association with at least one other portion of the computing code of: ones selected from a plurality of physical characteristics, ones selected from a plurality of clothes, ones selected from a plurality of accessories, a plurality of personal information, a plurality of preferences, and a plurality of recommendations.

### RELATED APPLICATIONS

This application claims the benefit under 35 U.S.C. 119(e) of U.S. Patent Application No. 61/207,980, entitled “System And Method For Providing Expert Search In A Modular Computing System,” filed Feb. 17, 2009, and is a continuation-in-part of U.S. patent application Ser. No. ______, entitled “A Widgetized Avatar And A Method And System Of Creating And Using Same” filed Nov. 20, 2009, which is a continuation of U.S. patent application Ser. No. 12/381,663, entitled “A Widgetized Avatar And A Method And System Of Creating And Using Same” filed Mar. 13, 2009, the entirety of each application being incorporated herein as if set forth in the entirety. This application is further related to U.S. patent application Ser. No. ______, entitled “A Widgetized Avatar And A Method And System Of Virtual Commerce Including Same,” U.S. patent application Ser. No. ______, entitled “A Widgetized Avatar And A Method And System Of Creating And Using Same,” and to U.S. patent application Ser. No. ______, entitled “A Virtual Marketplace Accessible To Widgetized Avatars,” All Filed Nov. 30, 2009, the entire disclosures of which are incorporated by reference herein as if each being set forth in their entirety.

### FIELD OF THE INVENTION

The present invention is directed to avatars for use in computing communities and, more particularly, to a widgetized avatar and a method and system of creating and using same.

### BACKGROUND OF THE INVENTION

Many computing and entertainment embodiments allow for a user, player, or viewer to create an “avatar.” An avatar is typically a virtual manifestation of that user's “computerized physicality.” However, the prior art typically provides only limited options for a user who wishes to create an avatar, such as limited physical features, clothing, associated information, and the like. As such, a typical avatar allows for only very limited information about a user to be relayed by the avatar. More specifically, the physical characteristics of the avatar likely have only limited applicability to the physicality of the real-world user, due in part to the limited physical, clothing and the like options available in creating the avatar, and the typical information associated with the avatar, other than its physicality, is limited or non-existent.

Additionally, present avatars need to be created over and over again, and are highly variable for the same real user as between different applications using an avatar, in principal part because avatars are not typically transferable as between multiple applications. Further, present avatars present little or no monetization or marketing opportunities, nor do present avatars allow for collection of or provision to, potential transaction partners of the preferences, characteristics or interests of the actual user.

Thus, the need exists for an avatar, and an apparatus, system and method related thereto, that allows for transferability, improved physical relation to the actual user, more information regarding the actual user, and improved marketing, monetization and transaction opportunities related to the user's avatar.

### SUMMARY OF THE INVENTION

An avatar is disclosed. The avatar includes computing code that provides for addition of the avatar as non-static content to at least two unique at least partially static web pages, and secondary computing code resident within the computing code, wherein the secondary computing code provides for association with at least one other portion of the computing code of: ones selected from a plurality of physical characteristics, ones selected from a plurality of clothes, ones selected from a plurality of accessories, a plurality of personal information, a plurality of preferences, and a plurality of recommendations.

A system for creating an online persona, including a widgetized avatar, and recommending content for viewing by a user of the online persona is also disclosed. The system includes computing code that provides for addition of the avatar as non-static content to at least two unique at least partially static web pages, secondary computing code resident within the computing code, wherein the secondary computing code provides for association with at least one other portion of the computing code of: ones selected from a plurality of physical characteristics, ones selected from a plurality of clothes, ones selected from a plurality of accessories, a plurality of personal information, a plurality of preferences, and a plurality of recommendations, and, a recommendation engine employing suitable to suggest content based on at least one of a user's community, popularity, known expertise, clicks, interests, and searches.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an avatar in accordance with the present invention;

FIG. 2 illustrates an avatar in accordance with the present invention;

FIG. 3 illustrates an avatar in accordance with the present invention;

FIG. 4 illustrates a plurality of avatars in accordance with the present invention; and

FIG. 5 illustrates a flow diagram in accordance with the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical avatar and computing apparatuses, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

An avatar is understood by one of ordinary skill in the art to include a computer user's representation of him or herself, such as in the form of a two or three dimensional model used in computer games, social network applications, or other on-line communities. A typical avatar may further include, or have associated therewith, a user's name, a user's screen name, a handle, or text of interest, such as a trademark, saying, or poem, for example.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

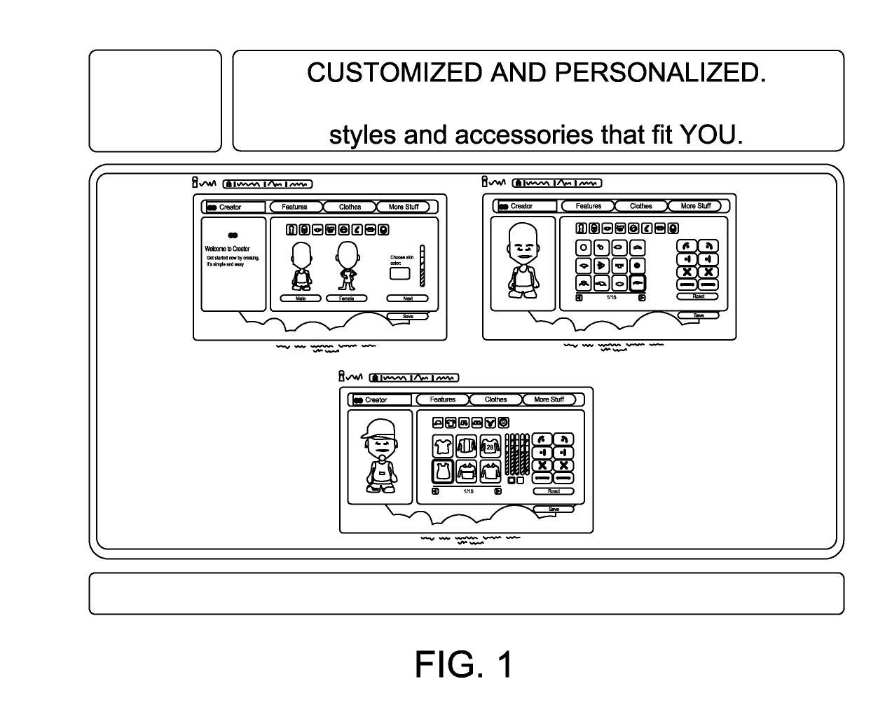

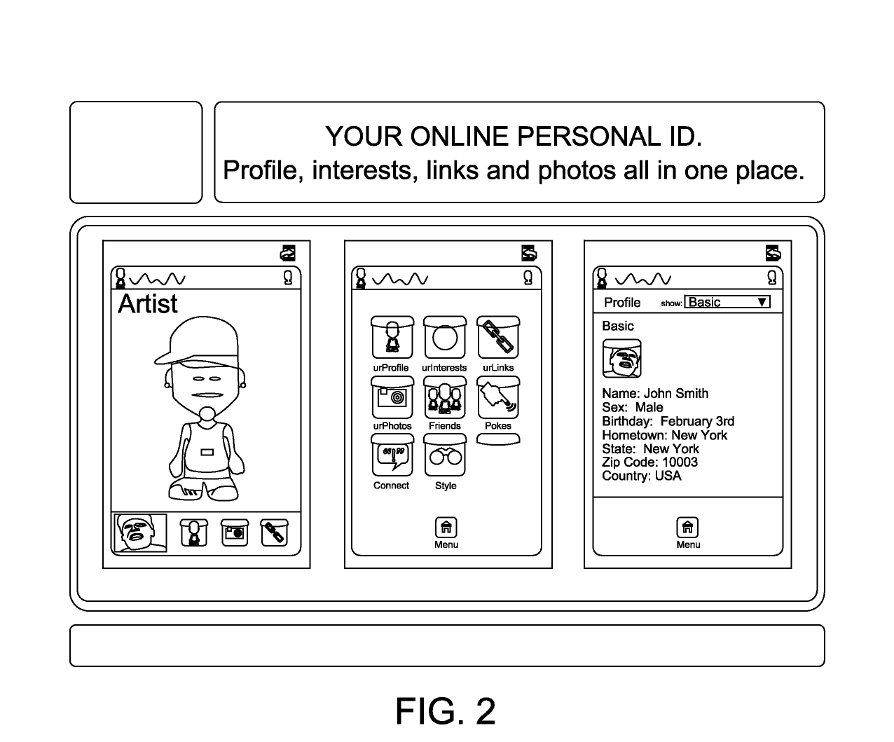

The present invention includes a fully portable, widgetized avatar having associated therewith multiple items of social information that are generally requested for association with at least two different computing communities or transactions. Widgetization of the avatar of the present invention necessarily allows for portability of the avatar of the present invention. For example, creation of a typical avatar in accordance with the present invention may include the association of physical features, such as facial and hair, with the subject avatar, as well as the aforementioned user name, as shown in FIG. 1. Further, a myriad of additional information may be associated with the avatar, wherein such information is generally required or desired for use in computing communities or transactions. This information may be organized into multiple levels of detail, and/or multiple levels of accessibility to third parties in a computing community or transaction. Such levels of accessibility may be selected by the creator of the widgetized avatar based on characteristics of the third party endeavoring to access the subject avatar. For example, a user may have basic information, which may be selectable for viewing by all registered users of a particular community, as shown in FIG. 2.

In an exemplary embodiment, a user may have likes or dislikes, such as musical or motion picture tastes, job or educational status, age, location, income, marital status, and other computed communities with which that user is associated, associated with his or her avatar. The present invention provides a physical manifestation of all of this information, such as in a “trading card” format. For example, FIG. 2 illustrates an avatar wherein the front of the virtual trading card includes an avatar having particular physical features, clothing, accessories, activities, and the like, along with an associated user name. However, when an interaction, such as selection of a drop-down menu, selection of a link, a double click, or the like is undertaken to “flip” a trading card to the back, a myriad of additional information is displayed regarding the user related to the widgetized avatar, such as age, interests, likes and dislikes, employment status, and the like.

Needless to say, because the virtual manifestation of the physical trading card is embodied in the computing code that provides for the virtual manifestation, such computing code may be provided in such a normalized format that it is easily adopted into multiple computing communities or environments, and/or may be adopted as non-static content onto multiple different web pages. As such, the subject avatar may be incorporated into multiple social communities, fantasy sports communities, blogs, and the like. Further, avatars of particular interest to the general public, such as trading card avatars of musical artists or other famous persons, may be downloaded or referenced by fans of such famous persons. Such avatars may, in fact, be presented in non-classical formats, such as through a tab presentation on a web page designed by the user as a home page in a certain community, or that is set forth by a particular computing community. Such “celebrity” avatars, including in such non-classical formats, may include presentations or allow for interactions with celebrity suggestions or favorites, such as recipes, music, concerts, movies, talk shows, reality shows, or the like, and may further allow for purchases from or related to such suggestions or favorites.

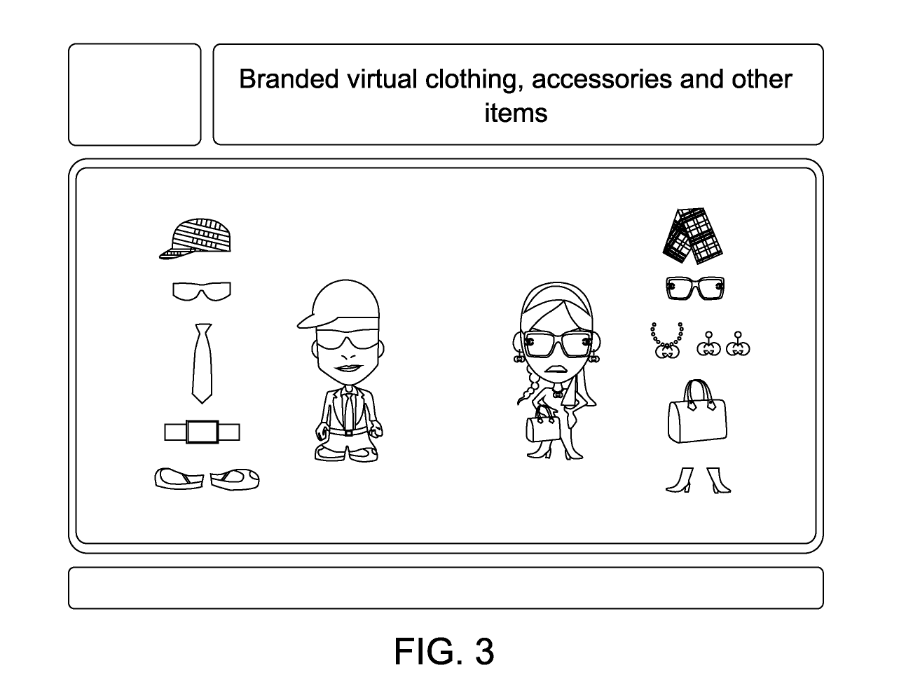

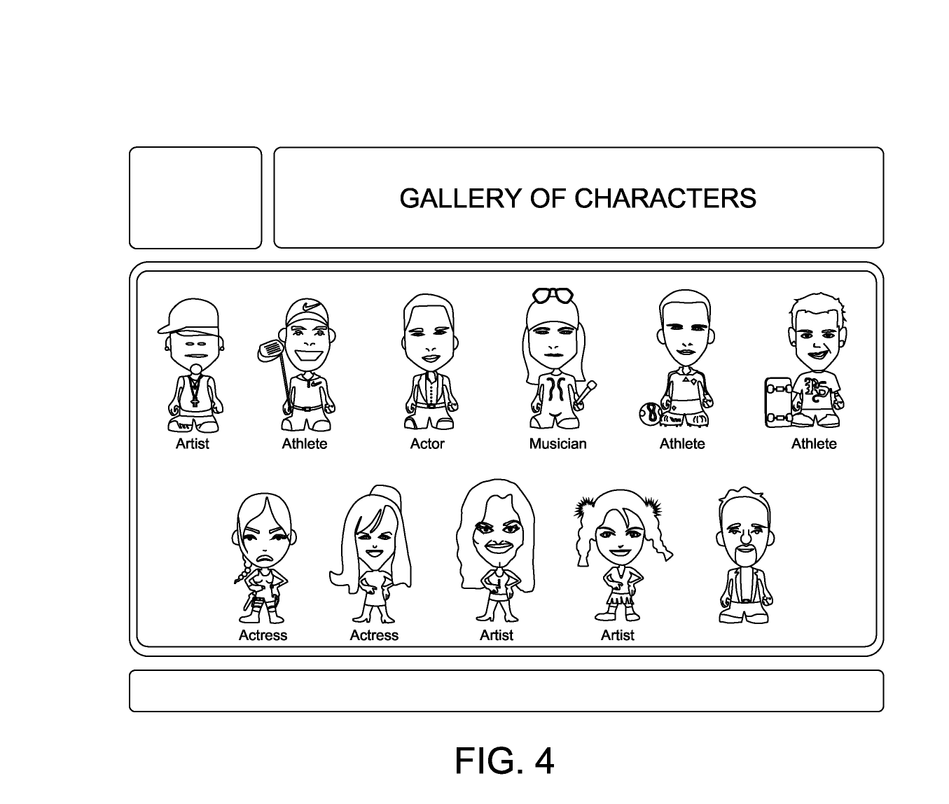

As referenced hereinabove, a typical avatar may have associated therewith certain physical features, clothing, accessories or activities, for example. As such, the present invention is and includes a tool whereby such physical features, clothing, accessories, and activities may be taken from the real world and “virtualized,” for use with a subject avatar, as shown in FIG. 3. For example, famous clothing lines, such as Vera Wang clothing, or famous shoe lines, such as Nike sneakers, or famous accessories, such as Kate Spade purses, or well known activities, such as playing for the Philadelphia Phillies, and goods at well known retailers, such as Tiffany's, Macy's, or the like, may be virtualized for use with an avatar. As such, virtualized items may be made available for sale for use with an avatar just as the corresponding real items are generally for sale for use with the real world user correspondent to the avatar. Likewise, celebrity avatars may be presented as “model” widgetized avatars, and the user may be enabled to purchase those items worn by the celebrity's avatar, and/or that are endorsed by that celebrity, as shown in FIG. 4.

Thereby, for example, during or following creation of a discreet widgetized avatar and/or a widgetized avatar to be associated with the aforementioned avatar trading card, the user creating the avatar may have available a selectable library of options for association with the subject avatar, such as a searchable library of options searchable by key word, or a hierarchal library of options presented by topic. Such libraries may be presented as “stores,” for example, in which the avatar may “shop.” For example, for “fashion”, a user may enter a fashion “shopping” environment, such as a virtual “mall,” to be presented with available virtual clothing lines for the avatar. Such lines may be visually presented by piece of clothing, or pieces of clothing on a shelf, for example, as would be the case in a real-world shopping for the real world user correspondent o the avatar. For example, for “shirts”, the user may be presented with options such as Jones New York, Tommy Hilfiger, Fubu, Major League Baseball, National Football League, and the like, and such options may be presented as storefronts, for example. The user may then select one of the presented fashion shopping points for shirts, and then may be presented with the entire line of “real world” shirts associated with that fashion line, but, of course in a virtualized format. Thus, for example, upon selection of a Major League Baseball store, the user may be presented with a series of major league baseball team jerseys for association with that user's avatar. Needless to say, the user may then select the baseball jersey of that user's favorite team, and may in fact pay, such as through the use of a micropayment, for the use of that virtual jersey just as the user might pay for the purchase of a real world jersey of that user's favorite baseball team in a real world store. Similarly, lines of pants, dresses, suits, shoes, and the like may be made available for use with avatars, and may in fact be made available for purchase by users for use with avatars. Likewise, accessories or activities that would require purchase in the real world by the user may additionally allow for purchase of such accessories or activities in the virtual world for use with the user's widgetized avatar.

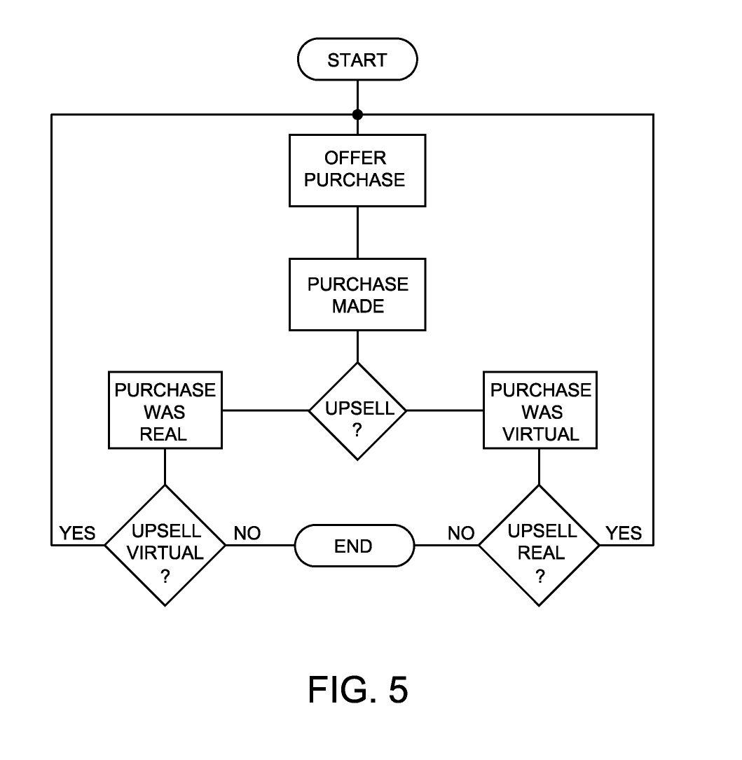

Additionally, the present invention may provide an upsell engine as illustrated in FIG. 5. The upsell engine may operate, upon purchase of a virtual item for association with the user's avatar, may present the user with an opportunity to purchase the same or similar article in the real world for real world use by the actual user based on that user's known preference for that article as evidenced by the purchase of the virtual article for use with the user's avatar. This may, of course, occur within an online store correspondent to the virtual store in which the avatar was “shopping.” The upsell engine may additionally or alternatively include presentation to the user of an advertisement for real world articles that are the same as or associated with the virtual article purchased by the user, or may allow for presentation of advertising related to likely related virtual or real world articles of interest to the user based on the user's expressed preference for the particular virtual article selected. Needless to say, the present invention may also be used to upsell in the inverse situation—that is, the situation in which the user purchases a real world article from a particular web site, or surfs a particular web site for real world goods and/or services, may cause the user to be presented with advertising for the purchase of the same or similar virtual articles, or associated or related virtual articles, or to be presented with a direct opportunity to purchase the same, similar, or related virtual articles at the point of purchase of the particular real world article.

Further, the present invention may allow for association of particular levels of expertise with particular areas of interest as related to the avatar trading card. As such, the user associated with the subject avatar may take a rating of that user's expertise in certain areas from computing community to computing community. Thus, searches may be made available in one or more computing communities for persons having desired levels of expertise in certain areas. The user may thus accumulate expertise points in multiple computing communities at the same time, wherein such points may be associated with that user's transferable widgetized avatar, whereby a user's expertise may rise based on accumulated expertise points. Additionally and alternatively, a user's expertise in a certain area may increase based on feedback from other users in one or more computing communities in relation to the subject users expertise in a particular area, or a user's expertise may increase based on an assignment of expertise levels by one or more of the computing communities, or a user's expertise level may rise based on advice offered, amount of advice offered, or purchase of expertise or advice from that user in or more on-line computing communities. Thus, a search by a party in need, such as a key word search, for an expert in a particular area may not return a user advertising to be an expert in a particular area, but instead may return a user adjudged to be an expert in a particular area by parties other than that user him or himself. Of course, in accordance with the present invention, such expertise levels may be associated with the avatar or avatar trading card, and as such may be subsequently transferred to other computing communities.

Thus, the avatar of the present invention enables a user to create a portable, fully virtual “person” for association with that user and carrying the characteristics of that user, including a personal profile and identification card that can be used in combination with any web page, webtop or desktop and any computing community, transaction or social networking situation. Thereby, the avatar of the present invention allows users to connect with other users and share ideas, content, expertise, and applications. Further, the avatar of the present invention thus assists in viral growth by offering users of certain or multiple computing communities an avatar that keeps all personal profile information in one transportable place. Additionally, the avatars of the present invention may provide a foundation for a recommendation and expertise engine employing an algorithm that may suggest content or an expert based on a user's community, popularity, known expertise, clicks, interests, searches, or the like.

The avatar of the present invention may include one or more of the user profile, physicality of avatar, user personal characteristics, user interests, user links, user photos, videos, or audio, user friends, user sayings, jokes, or the like, user notes, connections or message postings, and user clothing, accessories, activities and general style. As used herein, the computing communities and transactions to which the avatar of the present invention may be transferred include all computing communities, including telecommunications communities such as those accessible from cellular telephones, televisions, and the like.

Accordingly, virtual communities, such as a virtual mall, may be created in accordance with the present invention. A virtual mall may be equipped with a myriad of virtual “stores,” such stores having virtual, on-screen storefronts that may allow a user, such as via the aforementioned avatar, to virtually enter and shop at the store. Such stores may be mobile “widgets,” in a manner similar to the avatar discussed above, and as such may be placed in numerous online locations or communities, or may form a permanent part of a DNS mall location or community, for example. A user may shop within a virtual mall using an avatar or other similar online persona, as described hereinabove. Such an avatar may, for example, select a body type and/or style. Further, hair type, color and style have selected therefore clothing. This clothing may include tops, bottoms, shoes and accessories purchased at virtual stores that is, the online persona may mimic accessories and clothing accessible in a real world environment to the user.

As such, a virtual mall may present an online social community. This parallels the concept of a real world mall as a social networking point. The virtual mall of the present invention may be an extension of shopping as a social activity. Thus, a virtual mall may provide shopping, as well as a place to interact with friends, or to obtain and/or purchase entertainment.

The virtual mall may be presented as an outdoor mall, and/or may include mechanisms of a real world mall such as elevators, escalators, shuttles, hallways, movie theaters, food courts and the like. Similarly the virtual mall may take the form of an indoor mall, and/or may include with many levels of shopping. Alternatively, the virtual mall may take the form of a fantasy location, such as underwater, in outer space, or on the surface of the sun or moon, for example.

Users may browse through a virtual store in a manner similar to browsing in a real store. An avatar may enter different stores and look through merchandise. Such merchandise may be categorized based on a user query, or simply visible on-screen by type, for example. The virtual mall may thus provide virtual and/or online shopping, social networking, multiplayer games, movies and entertainment and the like. A user may interact with other mall shoppers, in real time or on a time delay, and may include seeking the best deals in groups, or “resting” virtual feet at a food court while catching up on the latest gossip or entertainment news.

Further, according to an aspect of the present invention, information regarding the user may be resident within the avatar of the present invention. This user and/or expertise information, as discussed above, may be used to populate a store or mall, wherein the stores offerings may be directed to the user profile associated the shopping avatar, or wherein the store provides offerings based on areas of expertise of the avatar of the storefront “owner.” For example, if user is interested in cars, such as European sports cars, for example, and this information is associated via the widget with the avatar, an automotive store may be provided by the mall to that user, with the “shelves” stocked with virtual and/or real/world parts for European sports cars, or cars, or car auctions, for example. Additionally, the sports car store may be an offering by a qualified expert in such cars, and as such, the user avatar may interact with an expert, namely the store “owner,” while shopping in the owner's virtual store. That is a user may interact with store personnel while shopping, such as via a chat.

Further, adjacent to the automotive store may be a store directed to another interest of the user. In fact, the mall may be populated with stores that match a user's interests. Such an automated mall or store populator may be provided as a site-building mechanism. More specifically, upon logging into or entering a virtual mall, the user's interest may be assessed, and during a brief pause, certain stores, or an entire mall, may be modified, added, removed, or otherwise populated to match the purchasing interests of the user, and/or for the user's avatar. Such a populator may be linked to the upsell engine discussed hereinabove, for example.

The virtual mall may allow for a user, via the user avatar, to simulate the shopping experience by browsing, searching, downloading, purchasing, and the like, and may provide checkout across multiple stores at checkout.

Controls may be used for moving the avatar about the mall and controlling avatar functions. For example, gaming controls may be configured to control avatar movements. For example, a joystick may be used. Alternatively, a keyboard control may be used, such as using the ⇑, ⇓, ←, and → keys, for example. The space bar may be used to rotate the avatar, for example. Alternatively, the keys W, A, S and D may direct the avatar through the virtual mall. The virtual mall may also have controls to run so that the avatar can get to stores quickly, or “teleport” to other stores, such as by clicking the mouse, for example.

Staffing, ownership or creation of the online storefront may be related to a person's status in the field to which the products pertain. For example, a user who has a significant experience in the field of cars may have an online storefront for autoparts, as described above.

Searching for a store at the mall, or an expert store across one or more malls, may be similar to searching on the web. The person operating a storefront may be an expert in the field to which the storefront pertains and thus may be subject to known searches as discussed above. The expert search may seek a person having increased level of expertise in searched area, in a particular environment, such as on one or more of the user's social networks, and/or may seek search results in accordance with those results found most useful by other experts, or by others seeking experts. An expert may, by being accorded expert status, be entitled to a storefront affiliated with the products or services with which the master is accorded expert status.

In fact, an expert may have multiple pages available for linking to upon searching, and may also have multiple online storefronts related to products or services to which the user is an expert. Each such page and/or storefront may relate to a different topic or area for searching, and therefore each such page may merit a different expertise rating for the user having such pages. Links from homepages, search results and storefronts may be available via navigation in and between such information sites.

A storefront or mall associated with an expert, in accordance with the present invention, may thus allow for keyword based searches to be performed in one or more search environments and/or on one or more computing communities, and/or or across one or more computing communities, i.e., social networks. Such a search may provide the traditional keyword search results, and may also provide links to an expert webpage or storefront, for example.

The expertise attribute, and other attributes, may either be entered by the user correspondent to the virtualization to which the expertise rating is assigned, or may be assigned algorithmically, such as by the computing community or across multiple computing communities, multiple malls, or the like. Thus, the management, creation and selling of products related to expertise via an online storefront may be algorithmically assigned. For example, as a certain user obtains ever increasing positive feedback, or as a certain user is returned more frequently responsive to a search for expert in a certain area, the rating associated with that user's storefront(s) may increase. Alternatively, a user may submit external information to a computing community to prove that user's level of expertise, and the computing community may respond in kind by assigning a particular level of expertise to that user.

Additionally and alternatively, experts in particular fields may advertise their expertise, individually or through their own storefronts, such as wherein an expertise level has been verified by the computing community, mall, or the like, and a searching user may search such “advertisements” in order to locate an expert storefront in a particular field.

Thus, the present invention, at least in part, may provide searching based on the relevancy of a storefront to a desired topic on which a purchase is sought, rather than the prior art methodology of keyword searching relating not to storefronts, but instead relating merely to websites, things, or advertised services that have no expertise rating associated therewith. Of course, this embodiment of the present invention allows the keyword revenue model of prior art search engines, such as Google®, to be employed in the monetization of searching for expert storefronts that can assist with topical purchases for avatar items or real world items associated with the particular keywords searched.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A virtual mall for shopping online, comprising:
at least one online virtual storefront that makes available for purchase avatar-related items in which a provider of said online virtual storefront has an expertise level;
an accumulator for accumulating online ratings indicative of the expertise level of the provider; and
an avatar representative of a user, and for which the purchase of the avatar-related goods is executed comprising:
first computing code that provides for addition of the avatar as non-static content to at least two unique at least partially static web pages, wherein said at least one online virtual storefront comprises at least a first of the at least two at least partially static webpages; and
second computing code that provides for association of said first computing code with a plurality of available virtual environments.

2. The mall of claim 1, wherein the avatar-related goods comprise at least one virtualized article of real world clothing.

3. The mall of claim 2, wherein the at least one article of real world clothing comprises a designer line of clothing.

4. The mall of claim 1, wherein said first computing code comprises uncompiled computing code.

5. The mall of claim 1, wherein a display of said first computing code comprises an approximate physical representation of the user.

6. The mall of claim 1, wherein a display of said first computing code is two dimensional.

7. The mall of claim 1, wherein a display of said first computing code is three dimensional.

8. The mall of claim 1, wherein said first computing code comprises personal information, including at least one of a user name, a user screen name, a purchase tool, a handle, a trademark and a text of interest.

9. The mall of claim 1, wherein said at least two unique at least partially static web pages comprise HTML code.

10. The mall of claim 1, wherein at least one of said first computing code and said second computing code are embeddable by the user.

11. The mall of claim 1, wherein a display of said first computing code includes at least facial features and hair.

12. The mall of claim 8, wherein the personal information includes musical tastes, motion picture tastes, job status, educational status, age, location, income, marital status, and online communities with which the user is associated.

13. The mall of claim 1, wherein a display of said first computing code comprises a trading card format.

14. The mall of claim 13, wherein said trading card format flips responsive to at least one of selection of a drop-down menu, selection of a link, and a double click.

15. The mall of claim 13, wherein a flipped side of said trading card includes age, interests, likes, dislikes, and employment status.

16. The mall of claim 8, wherein the personal information comprises an indication of the expertise level.

17. The mall of claim 16, wherein the expertise level is transferable in conjunction with said first computing code.

18. The mall of claim 16, wherein the expertise level is in accordance with feedback from other ones of the user in the at least one computing communities.
